(19) United States
(12) Patent Application Publication
(10) Pub. No.: US 2002/0147300 A1
(43) Pub. Date: Oct. 10, 2002

(54) Dampening water composition for lithographic printing plate

(76) Inventor: Hiroshi Matsumoto, Shizuoka-Ken (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/014,348

(22) Filed: Dec. 14, 2001

(30) Foreign Application Priority Data
Dec. 18, 2000 (JP) 2000-383394
Dec. 20, 2000 (JP) 2000-386327
Dec. 20, 2000 (JP) 2000-386328
Dec. 25, 2000 (JP) 2000-392162

(51) Int. Cl. C08G 73/00

(52) U.S. Cl. 528/422; 516/198; 252/194

(57) ABSTRACT

A dampening water composition for a lithographic printing plate comprising polyvinylpyrrolidone and at least one compound selected from the group consisting of acetylene alcohol, acetylene glycol, n-butyl alcohol, isobutyl alcohol, secondary-butyl alcohol, tertiary-butyl alcohol, a compound of (CH₃)₃C—O—(—CH₂—CH₂—O—)ₚ—H wherein p represents an integer of from 1 to 3, 3-methoxy-3-methylbutanol, 3-methoxybutanol, a compound represented by the following formula (I) and a compound represented by the following formula (II).

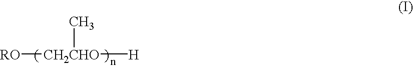

(wherein R represents n-butyl, isobutyl, tertiary-butyl or secondary-butyl group, and n represents an integer of 1 or 2.)

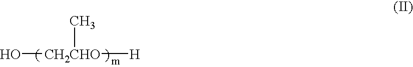

(wherein m represents an integer of from 1 to 3.)

Said dampening water composition is comfortable and safe in working atmosphere and is excellent in printing stability, which can replace a dampening water composition comprising isopropyl alcohol. Said dampening water also exhibits favorable and stable printing properties under the conditions of printing machine members which rotate at high speed, and stable printing properties to various ink compositions so as to obtain excellent printing matters.

### BACKGROUND OF THE INVENTION

The present invention relates to a dampening water composition useful for lithographic printing plate, and more specifically, to a dampening water composition which is useful for offset printing using a lithographic printing plate.

Lithographic printing technique makes the best use of the properties of water and an oil such that they are essentially incompatible with one another. The printing surface of a lithographic printing plate comprises areas which receive water and repel an oil ink and those which repel water and receive an oil ink, the former serving as non-image areas and the latter serving as image areas. The non-image areas become damp with damping water used in lithographic printing to thus enhance the difference in surface chemical properties between the image areas and the non-image area and hence to increase both the ink repellency of the non-image areas and the ink receptivity of the image areas.

As such conventional dampening water, there have been generally known aqueous solutions containing alkali metal salts or ammonium salt of bichromic acid, phosphoric acid or salts thereof such as ammonium salt, and a colloidal substance such as gum arabic or carboxymethyl cellulose (CMC). However, it is difficult to uniformly dampen the non-image areas of lithographic printing plates with the above dampening water, and for this reason, the resultant printed matters are sometimes contaminated and a substantial skill in controlling the feed rate of the dampening water is required.

To overcome such disadvantages, there has been proposed the Dahlgren dampening system in which an aqueous solution containing about 20 to 25% of isopropyl alcohol is used as a dampening water. This method provides a variety of advantages concerning workability and accuracy of printed matters, such that the dynamic wetting of the non-image areas is improved and the amount of the dampening water can be reduced, that it is easy to control the balance between feed rates of printing ink and dampening water, that the amount of water emulsified into the printing ink is lowered and that the transfer of printing ink to the blanket is improved.

However, isopropyl alcohol is apt to evaporate, and therefore the use of a special device is required for keeping the concentration of isopropyl alcohol constant. This is unfavorable from the economical point of view. Moreover, isopropyl alcohol gives out bad smell and is toxic and thus the use thereof is not favorable in view of the pollution of working atmosphere.

In addition, even if the dampening water containing isopropyl alcohol is applied to offset printing in which a dampening molleton roller is commonly used, isopropyl alcohol evaporates from a roller surface and the printing plate surface. Therefore, it cannot show its own effects.

Moreover, the pollution with industrial waste has recently become a matter of great concern, the regulation with respect to discharge of chromium ions in waste water becomes much severer and there is a tendency of controlling the use of organic solvents such as isopropyl alcohol from the viewpoint of safety and hygiene.

Accordingly, it has been desired to develop a dampening water composition for a lithographic printing plate which is of safety from the viewpoint of environment and hygiene, which does not require the technical skill for printing operation so that the feed rate of dampening water can be easily adjusted, and which is excellent in the dampening water properties such that which can prevent the contamination of a printing plate and which is suitable to a high speed printing so as to obtain printing matters having high quality.

### DATAILED EXPLANATION OF THE INVENTION

### Summary of the Invention

An object of the present invention is to provide a dampening water composition exhibiting excellent printing stability, which is comfortable and safe in working atmosphere, and which can replace a dampening water composition comprising isopropyl alcohol. Further object of the present invention is to provide a dampening water composition exhibiting favorable and stable printing properties under the conditions of printing machine members which rotate at high speed. Further object of the present invention is to provide a dampening water composition which exhibits stable printing properties to various ink compositions so as to obtain excellent printing matters.

Under such circumstances, the inventors of this invention have conducted various studies on a dampening water composition for a lithographic printing plate, and have found that combination use of polyvinylpyrrolidone and a specific compound accomplishes an excellent dampening water composition, which exhibits favorable dynamic wetting on a roller and a printing plate. Thus the inventors have completed the present invention.

Consequently, the present invention is directed to a dampening water composition for a lithographic printing plate comprising polyvinylpyrrolidone and at least one compound selected from the group consisting of acetylene alcohol, acetylene glycol, n-butyl alcohol, isobutyl alcohol, secondary-butyl alcohol, tertiary-butyl alcohol, a compound of (CH₃)₃C—O—(—CH₂—CH₂—O—)ₚ—H wherein p represents an integer of from 1 to 3, 3-methoxy-3-methylbutanol, 3-methoxybutanol, a compound represented by the following formula (I) and a compound represented by the following formula (II).

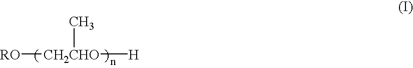

(wherein R represents n-butyl, isobutyl, tertiary-butyl or secondary-butyl group, and n represents an integer of 1 or 2.)

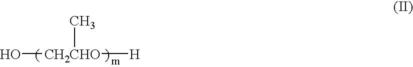

(wherein m represents an integer of from 1 to 3.)

In one embodiment, the present invention is a dampening water composition for a lithographic printing plate comprising polyvinylpyrrolidone and at least one selected from the group consisting of acetylene alcohol and acetylene glycol.

In another embodiment, the present invention is a dampening water composition for a lithographic printing plate comprising polyvinylpyrrolidone and at least one selected from the group consisting of n-butyl alcohol, isobutyl alcohol, secondary-butyl alcohol and tertiary-butyl alcohol.

In one embodiment, the present invention is a dampening water composition for a lithographic printing plate comprising polyvinylpyrrolidone and at least one selected from the group consisting of a compound of (CH₃)₃C—O—(—CH₂—CH₂—O—)ₚ—H wherein p represents an integer of from 1 to 3, 3-methoxy-3-methylbutanol and 3-methoxybutanol.

In another embodiment, the present invention is a dampening water composition for a lithographic printing plate comprising polyvinylpyrrolidone, a compound represented by the above formula (I) and a compound represented by the above formula (II).

### DESCRIPTION OF THE PREFERRED EMBODIMENTS

The present invention will be described in more detail below. Incidentally, a dampening water composition is generally commercialized as a concentrated dampening water composition, and such concentrated dampening water composition is properly diluted so as to prepare a dampening water composition in practical use. In this specification, contents or amounts described with respect to the components in the composition are on the basis of the total weight of the dampening water composition in practical use, unless otherwise specified.

Polyvinylpyrrolidone used in the dampening water composition according to the present invention denotes homopolymers of vinylpyrrolidone. Said polyvinylpyrrolidone is suitably those having molecular weight of from 200 to 3,000,000 preferably from 300 to 500,000, and more preferably from 300 to 100,000. The polyvinylpyrrolidone may be used alone, or may be used in combination of those having diverse molecular weights. If the polyvinylpyrrolidone having molecular weight of more than 100,000 is used, it tends to cause blinding on the run, i.e., deterioration of ink-receptivity in the plate image division, and roller-strip of an ink roller of a printing machine during printing operation, and therefore it is preferable to use in combination, polyvinylpyrrolidone having low molecular weight, for example, vinylpyrrolidone oligomer having a degree of polymerization of from 3 to 5.

As the above polyvinylpyrrolidone, commercial products may be used. Examples of the commercial product of polyvinylpyrrolidone include various grades of K-15, K-30, K-60, K-90, K-120 and the like which are manufactured by ISP Co., Ltd.

The amount of polyvinylpyrrolidone in the dampening water composition ranges suitably from 0.001 to 0.5% by weight, and preferably from 0.005 to 0.3% by weight, and more preferably 0.005 to 0.2% by weight.

In one aspect of the present invention, at least one selected from acetylene alcohol and acetylene glycol is used in combination with polyvinylpyrrolidone in a dampening water composition.

“Acetylene alcohol” denotes an unsaturated alcohol having an acetylene bond (triple bond) in the molecule thereof, and examples of the acetylene alcohol used in the present invention are described below.

(1) Propargyl alcohol

CH≡C—CH₂OH

(2) Propargyl carbinol

CH≡C—CH₂—CH₂OH

(3) 3,5-Dimethyl-1-hexyne-3-ol

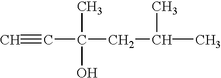

(4) 3-Methyl1-butyne-3-ol

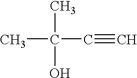

(5) 3-Methyl-1-pentyne-3-ol

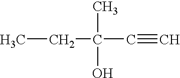

Acetylene glycol is also called alkyne diol, which is an unsaturated glycol having an acetylene bond (triple bond) in the molecule thereof, and examples of the acetylene glycol used in the present invention are described below.

(6) 1,4-Butyne diol

HO—CH₂—C═C—CH₂—H

(7) 2,5-Dimethyl-3-hexyne-2,5-diol

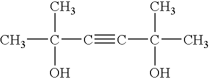

(8) 3,6-Dimethyl-4-octine-3,6-diol

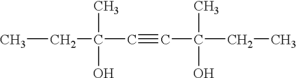

(9) 2,4,7,9-Tetramethyl-5-decyne-4,7-diol

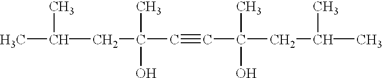

(10) Ethylene oxide adduct of 2,4,7,9-tetramethyl-5-decyne-4,7-diol

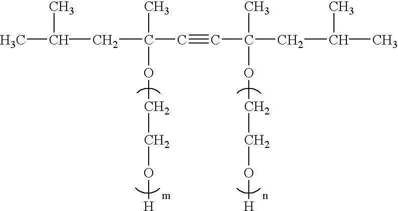

(11) 2,5,8,11-Tetramethyl-6-dodecyne-5,8-diol

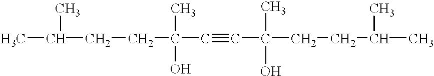

These acetylene alcohol and acetylene glycol are commercially available and there is known, for example, a commercial product by Air Products and Chemicals Inc. under the trade name of SURFYNOL. Examples of such a commercial product include SURFYNOL 61 represented by the above formula (3), OLFIN B represented by the above formula (4), OLFIN P represented by the above formula (5), OLFIN Y represented by the above formula (7), SURFYNOL 82 represented by the above formula (8), SURFYNOL 104 represented by the above formula (9), SURFYNOL 400 series represented by the above formula (10) and SURFYNOL DF-110 represented by the above formula (11).

Among them, it is preferable to use the ethylene oxide adduct of 2,4,7,9-tetramethyl-5-decyne-4,7-diol represented by the above formula (10), and more specifically those wherein m+n=1 to 30.

In the dampening water composition according to the present invention, it is possible to use one alone selected from the group consisting of acetylene alcohol and acetylene glycol, or two or more selected from them in combination.

The amount of at least one selected from the group consisting of acetylene alcohol and acetylene glycol in the dampening water composition suitably ranges from 0.001 to 0.2% by weight, and more preferably from 0.005 to 0.1% by weight.

In one aspect of the present invention, at least one selected from the group consisting of n-butyl alcohol, isobutyl alcohol, secondary-butyl alcohol and tertiary-butyl alcohol is used in combination with polyvinylpyrrolidone in a dampening water composition.

Among these butyl alcohols, tertiary-butyl alcohol is preferably used. In the dampening water composition according to the present invention, it is possible to use one alone selected from these butyl alcohols, or two or more selected from them in combination.

The amount of at least one selected from the group consisting of n-butyl alcohol, isobutyl alcohol, secondary-butyl alcohol and tertiary-butyl alcohol in the dampening water composition suitably ranges from 0.1 to 3.0% by weight, and more preferably from 0.5 to 2.0% by weight.

In one aspect of the present invention, at least one selected from the group consisting of a compound of (CH₃)₃C—O—(—CH₂—CH₂—O—)ₚ—H wherein p represents an integer of from 1 to 3, 3-methoxy-3-methylbutanol and 3-methoxybutanol is used in combination with polyvinylpyrrolidone in a dampening water composition. The compound of (CH₃)₃C—O—(—CH₂—CH₂—O—)ₚ—H wherein p represents an integer of from 1 to 3 includes ethylene glycol mono tertiary-butyl ether, diethylene glycol mono tertiary-butyl ether and triethylene glycol mono tertiary-butyl ether.

Among them, ethylene glycol mono tertiary-butyl ether and 3-methoxy-3-methylbutanol are preferably used. In the dampening water composition according to the present invention, it is possible to use one alone selected from these compound, or two or more selected from them in combination.

The amount of at least one selected from the group consisting of a compound of (CH₃)₃C—O—(—CH₂—CH₂—O—)ₚ—H wherein p represents an integer of from 1 to 3, 3-methoxy-3-methylbutanol, 3-methoxybutanol in the dampening water composition suitably ranges from 0.01 to 5.0% by weight, and more preferably from 0.05 to 3.0% by weight.

In one aspect of the present invention, a compound represented by the formula (I) and a compound represented by the formula (II) are used in combination with polyvinylpyrrolidone in a dampening water composition.

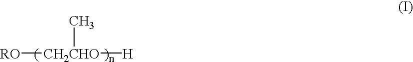

(wherein R represents n-butyl, isobutyl, tertiary-butyl or secondary-butyl group, and n represents an integer of 1 or 2.)

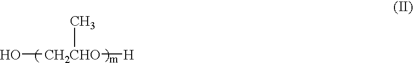

(wherein m represents an integer of from 1 to 3.)

The compound represented by the formula (I) includes propylene glycol mono n-butyl ether, propylene glycol mono isobutyl ether, propylene glycol mono secondary-butyl ether, propylene glycol mono tertiary-butyl ether, dipropylene glycol mono n-butyl ether, dipropylene glycol mono isobutyl ether, dipropylene glycol mono secondary-butyl ether and dipropylene glycol mono tertiary-butyl ether. These compounds may be used alone or in any combination of at least two of them. The amount of the compound represented by the formula (I) in the dampening water composition suitably ranges from 0.05 to 2.0% by weight, and more preferably from 0.1 to 1.0% by weight.

The compound represented by the formula (II) includes propylene glycol, dipropylene glycol and tripropylene glycol. These compounds may be used alone or in any combination of at least two of them. The amount of the compound represented by the formula (II) in the dampening water composition suitably ranges from 0.1 to 3.0% by weight, and more preferably from 0.3 to 2.0% by weight.

The dampening water composition according to the present invention may further comprise the following additives:

(a) an agent for improving dynamic wetting,

(b) a hydrophilic polymeric compound other than polyvinylpyrrolidone,

(c) a pH-buffering agent,

(d) an odor-masking agent, and

(e) others (\mathring{1} an antiseptic agent, \mathring{2} a chelating agent, \mathring{3} a coloring agent, \mathring{4} an anti-corrosion agent, and \mathring{5} an anti-foaming agent).

As the agent for improving dynamic wetting (compound (a)), surfactants or others may be used.

Examples of anionic surfactants include fatty acid salts, abietic acid salts, hydroxyalkanesulfonic acid salts, alkanesulfonic acid salts, dialkyl sulfosuccinate salts, linear alkyl benzenesulfonate salts, branched alkyl benzenesulfonate salts, alkyl naphthalenesulfonate salts, alkylphenoxy polyoxyethylenepropyl-sulfonate salts, polyoxyethylene alkylsulfophenyl ether salts, sodium salt of N-methyl-N-oleyltaurine, disodium salt of N-alkylsulfosuccinic acid monoamide, petroleum sulfonic acid salts, sulfated castor oil, sulfated tallow, sulfuric acid ester salts of fatty acid alkyl esters, alkylsulfate ester salts, polyoxyethylene alkyl ether sulfuric acid ester salts, fatty acid monoglyceride sulfuric acid ester salts, polyoxyethylene alkylphenyl ether sulfuric acid ester salts, polyoxyethylene styrylphenyl ether sulfuric acid ester salts, alkylphosphate ester salts, polyoxyethylenealkyl ether phosphoric acid ester salts, polyoxyethylenealkylphenyl ether phosphoric acid ester salts, partially saponified styrene-maleic anhydride copolymers, partially saponified olefin-maleic anhydride copolymers and condensates of naphthalene sulfonic acid salt and formalin. Among these, particularly preferred are dialkylsulfosuccinic acid salts, alkylsulfate ester salts and alkylnaphthalenesulfonic acid salts.

Examples of non-ionic surfactants include polyoxyethylene alkyl ethers, polyoxyethylene alkylphenyl ethers, polyoxyethylene polystyrylphenyl ethers, polyoxyethylene polyoxypropylene alkyl ethers, partial esters of glycerin-fatty acids, partial esters of sorbitan-fatty acids, partial esters of, pentaerythritol-fatty acids, propylene glycol monofatty acid ester, partial esters of sucrose-fatty acids, partial esters of polyoxyethylene sorbitan fatty acids, partial esters of polyoxyethylene sorbitol fatty acids, polyethylene glycol fatty acid esters, partial esters of polyglycerin fatty acids, castor oils modified with polyoxyethylene, partial esters of polyoxyethylene glycerin fatty acids, fatty acid diethanolamides, N,N-bis-2-hydroxyalkylamines, polyoxyethylene-alkylamines, triethanolamine fatty acid ester, polyoxyethylene-polyoxypropylene block copolymers, trialkylamine oxides, fluorine atom-containing surfactants and silicon atom-containing surfactants. Particularly preferred are polyoxyethylene alkylphenyl ethers, polyoxyethylene-polyoxypropylene block copolymers and the like, among others.

In addition, surfactants such as silicon derivatives and fluorine derivatives are also used.

The amount of the surfactant to be incorporated in the dampening water composition is not more than 1.0% by weight taking the foaming properties into consideration, and preferably from 0.001 to 0.5% by weight based on the total weight of the composition. These surfactants may be used alone or in combination.

The others include ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monopropyl ether, diethylene glycol monopropyl ether, triethylene glycol monopropyl ether, tetraethylene glycol monopropyl ether, ethylene glycol monoisopropyl ether, diethylene glycol monoisopropyl ether, triethylene glycol monoisopropyl ether, tetraethylene glycol monoisopropyl ether, ethylene glycol mono n-butyl ether, diethylene glycol mono n-butyl ether, triethylene glycol mono n-butyl ether, tetraethylene glycol mono n-butyl ether, ethylene glycol monoisobutyl ether, diethylene glycol monoisobutyl ether, triethylene glycol monoisobutyl ether, tetraethylene glycol monoisobutyl ether, tetraethylene glycol mono tertiary-butyl ether, propylene glycol monomethyl ether, dipropylene glycol monomethyl ether, tripropylene glycol monomethyl ether, tetraprolylene glycol monomethyl ether, propylene glycol monoethyl ether, dipropylene glycol monoethyl ether, tripropylene glycol monoethyl ether, tetrapropylene glycol monoethyl ether, propylene glycol monopropyl ether, dipropylene glycol monopropyl ether, tripropylene glycol monopropyl ether, propylene glycol monoisopropyl ether, dipropylene glycol monoisopropyl ether, tripropylene glycol monoisopropyl ether, propylene glycol mono n-butyl ether, dipropylene glycol mono n-butyl ether, tripropylene glycol mono n-butyl ether, propylene glycol mono isobutyl ether, dipropylene glycol mono isobutyl ether, tripropylene glycol mono isobutyl ether, propylene glycol mono tert-butyl ether, dipropylene glycol mono tert-butyl ether, tripropylene glycol mono tert-butyl ether, polypropylene glycol having molecular weights ranging from 200 to 1000, monomethyl ether, monoethyl ether, monopropyl ether, monoisopropyl ether or monobutyl ether thereof, prolylene glycol, dipropylene glycol, tripropylene glycol, tetrapropylene glycol, pentapropylene glycol, ethylene glycol, diethylene glycol, triethylene glycol, butylene glycol, hexylene glycol, 2-ethyl-1,3-hexane diol, glycerin, diglycerin, polyglycerin, trimethyrol propane and the like.

These solvents may be used alone or in combination. The amount of these solvents in the dampening water composition ranges generally from 0.01 to 3% by weight, and preferably from 0.01 to 2% by weight.

The hydrophilic polymeric compound (compound (b)) used in the dampening water composition of the present invention include gum arabic, starch derivatives, for instance, dextrin, enzyme-modified dextrin, bydroxypropylated enzyme-modified dextrin, carboxymethylated starch, starch phosphate and octenyl succinated starch, alginates or cellulose derivatives, for instance, carboxymethyl cellulose, carboxyethyl cellulose, methyl cellulose, and modified derivatives thereof, and such a synthetic substance as polyethylene glycol and copolymers thereof, polyvinyl alcohol and derivatives thereof, polyacrylamide and copolymers thereof, polyacrylic acid and copolymers thereof, vinyl methyl ether/maleic anhydride copolymers, vinyl acetate/maleic anhydride copolymers and polymer of styrenesulfonic acid and copolymers thereof.

If such hydrophilic polymeric compound is used, the amount of the hydrophilic polymeric compound in the dampening water composition ranges suitably from 0.0001 to 0.1% by weight, and more preferably ranges from 0.0005 to 0.05% by weight.

As a pH-buffering agent (compound (c)) used in the dampening water composition of the present invention, water-soluble organic acids, water-soluble inorganic acids and salts thereof can be used, and they exhibit a pH-controlling or buffering effect, an effect of properly etching the surface of a substrate for a lithographic printing plate or a corrosion-inhibitory effect. Examples of preferred organic acids are citric acid, ascorbic acid, malic acid, tartaric acid, lactic acid, acetic acid, gluconic acid, hydroxyacetic acid, oxalic acid, malonic acid, levulinic acid, sulfanilic acid, p-toluene sulfonic acid, phytic acid, organic phosphonic acid and the like. Examples of inorganic acids are phosphoric acid, polyphosphoric acid, nitric acid and sulfuric acid. Further, alkali metal salts, alkaline earth metal salts, ammonium salts and/or organic amine salts of the organic acids and/or the inorganic acids may also be used. These organic acids, inorganic acids and/or salts thereof may be used alone or in combination.

The amount of these organic, inorganic acids and/or salts thereof to be added to the dampening water composition preferably ranges from 0.001 to 0.3% by weight and is appropriately selected such that pH of the resulting dampening water ranges from 3 to 7 of acidic region. Alternatively, the dampening water composition can also be used in an alkaline region of pH 7 to 11 if alkali metal hydroxides, alkali metal phosphate, alkali metal carbonates and/or silicates are used as the pH-buffering component.

The odor-masking agent (compound (d)) includes esters which are conventionally known as aroma chemicals such as the compounds represented by the following formula (III).

R¹—COOR² (III)

In the formula (III), R¹ represents hydrogen atom, an alkyl, alkenyl or aralkyl group having carbon atoms of 1 to 15, or phenyl group. When R¹ represents an alkyl or alkenyl group, said alkyl or alkenyl group may preferably have carbon atoms of 4 to 8. When R¹ represents an alkyl, alkenyl or aralkyl group, they may have a straight chain or a branched chain. Said alkenyl group may have preferably one double bond. Said aralkyl group includes benzyl group and phenylethyl group. At lease one hydrogen atom in the alkyl, alkenyl or aralkyl group of R¹ may be substituted with hydroxyl group or acetyl group.

In the formula (III), R² represents an alkyl or aralkyl group having carbon atoms of 3 to 10 or phenyl group, and they may be in the form of straight chain or branched chain. When R² represents an alkyl group, said alkyl group may preferably have carbon atoms of 3 to 9. The aralkyl group includes benzyl group and phenylethyl group.

Specific examples of the odor-masking agent (compound (d)) which may be used are esters of formic acid, acetic acid, propionic acid, butyric acid, isobutyric acid, 2-ethyl butyric acid, valeric acid, isovaleric acid, 2-methyl valeric acid, hexanoic acid (caproic acid), 4-methyl pentanoic acid (isohexanoic acid), 2-hexenoic acid, 4-pentenoic acid, heptanoic acid, 2-methylheptanoic acid, octanoic acid (caplyric acid), nonanoic acid, decanoic acid (capric acid), 2-decenoic acid, lauric acid or myristic acid. Others include benzyl phenylacetate, and acetoacetic esters such as ethyl acetoacetate, 2-hexyl acetoacetate and the like.

Among these compounds, preferred are n-pentyl acetate, isopentyl acetate, n-butyl butyrate, n-pentyl butyrate and isopentyl butyrate, and especially preferred are n-butyl butyrate, n-pentyl butyrate and isopentyl butyrate.

The amount of the odor-masking agent (compound (d)) in the dampening water composition ranges in general, from 0.0001 to 10% by weight, and more preferably from 0.001 to 1% by weight. The use of these compounds can improve the working atmosphere. It is possible to use additionally vanillic aldehyde, ethyl vanillic aldehyde and the like.

The antiseptic agent (compound (e)\mathring{1}) used in the dampening water composition includes phenol or derivatives thereof, formalin, imidazole derivatives, sodium dehydroacetate, 4-isothiazoline-3-one derivatives, benzotriazole derivatives, amidine or guanidine derivatives, quaternary ammonium salts, pyridine, quinoline or guanidine derivatives, diazine or triazole derivatives, oxazole and oxazine derivatives, bromonitroalcohols such as bromonitro propanol, 1,1-dibromo-1-nitro-2-ethanol, 3-bromo-3-nitropentane-2,4-diol and the like. These antiseptic agent are used in such an amount that they can effectively and steadily inhibit the growth of bacteria, mold, yeast or the like and the amount thereof varies depending on the kinds of bacteria, mold, yeast or the like to be controlled but preferably ranges from 0.001 to 1.0% by weight on the basis of the total weight of the dampening water composition. In this respect, these antiseptic agents are preferably used in combination so that the composition is effective for controlling various kinds of mold, bacteria and yeast.

The dampening water composition of the present invention may further comprise a chelating agent (compound (e)\mathring{1}.

Usually, the dampening water composition is prepared by diluting a concentrated dampening water composition with tap water or well water for practical use. Tap water or well water generally contains ions such as calcium ions which exert adverse influences on printing and the presence thereof often causes contamination of printed matters. These problems can effectively be solved if the dampening water composition comprises a chelating agent. Examples of preferred chelating agents include ethylenediamine-tetraacetic acid and potassium or sodium salt thereof; diethylenetriamine-pentaacetic acid and potassium or sodium salt thereof; triethylenetetramine-hexaacetic acid and potassium or sodium salt thereof, hydroxyethyl ethylenediamine-triacetic acid and potassium or sodium salt thereof; nitrilotriacetic acid and potassium or sodium salt thereof; and such an organophosphonic acid as 1-hydroxyethane-1,1-diphosphonic acid, potassium or sodium salt thereof, aminotri(methylenephosphonic acid), potassium or sodium salt thereof; and phosphonoalkane tricarboxylic acid or salts thereof. Organic amine salts of the foregoing chelating agents may be used effectively instead of potassium and sodium salts thereof. These chelating agents should be selected so that they are stably present in the concentrated dampening water and exhibit no printing inhibitory effect. These chelating agents are used in the dampening water composition in an amount ranging from 0.001 to 0.1% by weight, and preferably 0.005 to 0.05% by weight.

As coloring agents (compound (e)\mathring{3}) used in the dampening water composition according to the present invention, food dyes are preferably used. For example, there are yellow dyes such as CI Nos. 19140 and 15985; red dyes such as CI Nos. 16185, 45430, 16255, 45380 and 45100; purple dyes such as CI No. 42640; blue dyes such as CI Nos. 42090 and 73015; green dyes such as CI No. 42095 and the like.

Examples of the anti-corrosion agents (compound (e)\mathring{4}) used in the dampening water composition of the present invention include benzotriazole, 5-methylbenzotriazole, thiosalicylic acid, benzimidazole and derivatives thereof.

Preferred antifoaming agents (compound (e)\mathring{5}) which may be used in the dampening water composition of the present invention are silicone type ones and they may be used in the form of either emulsion dispersions or solubilized solutions.

The remainder of the dampening water composition according to the present invention is water.

Incidentally, a dampening water composition is generally commercialized as a concentrated dampening water composition, and such concentrated dampening water composition is properly diluted so as to prepare a dampening water composition in practical use. Accordingly, the above components are dissolved in water, preferably demineralized water, i.e., pure water to obtain an aqueous solution which is the concentrated dampening water composition. The concentrated dampening water composition is usually diluted from 10 to 200 times with tap water or well water prior to the practical use, and the dampening water composition for practical use is obtained.

The dampening water composition of the present invention will hereunder be explained in more detail with reference to the following non-limitative working examples and comparative examples. In the following Examples and Comparative Examples, the term “%” means “% by weight”, unless otherwise specified.

### EXAMPLES 1 TO 20 AND COMPARATIVE EXAMPLES 1 TO 7

According to the compositions shown in Tables 1 to 4, the compositions for dampening water were prepared. The unit of numerical value is “gram”, and water is finally added up to 1000 ml in total volume of the composition. All the compositions thus prepared are concentrated types, and they will be diluted when practically used.

In the following tables, Comparative Example is referred to as “Com. Ex.”.

TABLE 1

| | | | | | | Com. |
|---|---|---|---|---|---|---|
| | Examples | | | | | Ex. |
| Components | 1 | 2 | 3 | 4 | 5 | 1 |
| [Polyvinylpyrrolidone] | | | | | | |
| Molecular weight: 300˜500 | — | 20 | — | 30 | — | — |
| K-15 (molecular weight: | 40 | — | 30 | — | 20 | — |
| 6,000˜15,000) | | | | | | |
| K-30 (molecular weight: | — | 20 | — | 10 | 20 | — |
| 40,000˜80,000) | | | | | | |
| [Acetylne alcohol/ | | | | | | |
| Acetylene glycol] | | | | | | |
| SURFYNOL 420 | 1.5 | — | — | 1.0 | — | — |
| SURFYNOL 440 | — | 2.0 | — | 1.0 | 1.0 | — |
| SURFYNOL 465 | 0.5 | — | 1.5 | — | 0.5 | — |
| SURFYNOL 104E | — | 0.2 | 0.5 | 0.1 | 0.5 | — |
| SURFYNOL 82 | — | — | — | 0.1 | — | — |
| Ethylene glycol mono n-butyl | 20 | — | — | — | 10 | — |
| ether | | | | | | |
| Diethylene glycol mono | — | 20 | — | — | — | — |
| n-butyl ether | | | | | | |
| Propylene glycol mono | — | — | 10 | 10 | 10 | 10 |
| n-butyl ether | | | | | | |
| Propylene glycol mono t-butyl | 20 | — | — | 5 | — | — |
| ether | | | | | | |
| Ethylene glycol mono t-butyl | — | 10 | 30 | 20 | 15 | 30 |
| ether | | | | | | |
| Propylene glycol | — | 10 | — | 10 | 15 | — |
| [pH-buffering agent] | | | | | | |
| Malic acid | 10 | 10 | 10 | 10 | 10 | 10 |
| Ammonium citrate | 5 | 5 | 5 | 5 | 5 | 5 |
| Ammonium phosphate | 8 | 8 | 8 | 8 | 8 | 8 |
| [Antiseptic agent] | | | | | | |
| 4-Isothiazoline-3-one | 2 | 2 | 2 | 2 | 2 | 2 |
| derivative | | | | | | |

| | |
|---|---|
| Pure water | Up to 1000 ml in total volume of |
| | the composition |

TABLE 2

| | Examples | | | | | Com. Ex. | |
|---|---|---|---|---|---|---|---|
| Components | 6 | 7 | 8 | 9 | 10 | 2 | 3 |
| [Polyvinylpyrrolidone] | | | | | | | |
| K-15 (molecular | 30 | — | — | 20 | 30 | — | — |
| weight: 6,000˜15,000) | | | | | | | |
| K-30 (molecular | — | 30 | — | 20 | 5 | — | — |
| weight: | | | | | | | |
| 40,000˜80,000) | | | | | | | |
| K-60 (molecular | — | — | 30 | — | 5 | — | — |
| weight: | | | | | | | |
| 240,000˜450,000) | | | | | | | |
| n-Butyl alcohol | — | — | — | 50 | 50 | — | — |
| Isobutyl alcohol | — | 50 | — | — | 50 | — | 50 |
| sec-Butyl alcohol | — | — | 50 | — | — | — | — |
| tert-Butyl alcohol | 300 | 250 | 250 | 250 | 200 | 300 | 250 |
| Hydroxy- | — | — | — | — | — | 30 | — |
| propylcellulose | | | | | | | |
| (HPC low molecular | | | | | | | |
| weight) | | | | | | | |
| Propylene glycol | 50 | 50 | 50 | 50 | 50 | 50 | 50 |
| mono n-butyl ether | | | | | | | |
| Propylene glycol | 50 | 50 | 50 | 50 | 50 | 50 | 50 |
| [pH-buffering agent] | | | | | | | |
| Malic acid | 10 | 10 | 10 | 10 | 10 | 10 | 10 |
| Ammonium citrate | 10 | 10 | 10 | 10 | 10 | 10 | 10 |
| Phosphoric acid (85%) | 3 | 3 | 3 | 3 | 3 | 3 | 3 |
| [Antiseptic agent] | | | | | | | |
| 4-Isothiazoline-3-one | 2 | 2 | 2 | 2 | 2 | 2 | 2 |
| derivative | | | | | | | |

| | |
|---|---|
| Pure water | Up to 1000 ml in total volume of the |
| | composition |

TABLE 3

| | Examples | | | | | Com. Ex. | |
|---|---|---|---|---|---|---|---|
| Components | 11 | 12 | 13 | 14 | 15 | 4 | 5 |
| [Polyvinylpyrrolidone] | | | | | | | |
| Molecular weight: 300˜500 | — | 20 | — | 5 | — | — | — |
| K-15 (molecular weight: | 40 | — | 40 | 30 | 30 | — | — |
| 6,000˜15,000) | | | | | | | |
| K-30 (molecular weight: | — | 20 | — | 5 | 10 | — | — |
| 40,000˜80,000) | | | | | | | |
| Ethylene glycol mono t-butyl ether | 30 | — | — | — | 20 | 30 | — |
| 3-Methyl-3-methoxybutanol | — | 20 | 30 | — | 20 | — | 20 |
| 3-Methoxybutanol | — | — | — | 30 | — | — | — |
| Hydroxypropylcellulose | — | — | — | — | — | 40 | 40 |
| (HPC low molecular weight) | | | | | | | |
| Propylene glycol mono n-butyl ether | 9 | 10 | 10 | 9 | 5 | 9 | 10 |
| Propylene glycol mono t-butyl ether | — | 10 | 5 | — | — | — | 10 |
| Propylene glycol | — | — | — | — | 5 | — | — |
| Octylene glycol | 1 | 1 | 1 | 1 | 1 | 1 | 1 |
| [pH-buffering agent] | | | | | | | |
| Malic acid | 10 | 10 | 10 | 10 | 10 | 10 | 10 |
| Ammonium citrate | 10 | 10 | 10 | 10 | 10 | 10 | 10 |
| Ammonium phosphate | 5 | 5 | 5 | 5 | 5 | 5 | 5 |
| [Antiseptic agent] | | | | | | | |
| 4-Isothiazoline-3-one derivative | 4 | 4 | 4 | 4 | 4 | 4 | 4 |

| | |
|---|---|
| Pure water | Up to 1000 ml in total volume of |
| | the composition |

TABLE 4

| | Examples | | | | | Com. Ex. | |
|---|---|---|---|---|---|---|---|
| Components | 16 | 17 | 18 | 19 | 20 | 6 | 7 |
| [Polyvinylpyrrolidone] | | | | | | | |
| K-15 (molecular | 30 | — | 20 | 10 | 15 | — | — |
| weight: | | | | | | | |
| 6,000˜15,000) | | | | | | | |
| K-30 (molecular | — | 30 | 10 | 20 | 15 | — | — |
| weight: | | | | | | | |
| 40,000˜80,000) | | | | | | | |
| [Compound of | | | | | | | |
| Formula (I)] | | | | | | | |
| Propylene glycol mono | 100 | — | — | 100 | 50 | 100 | 100 |
| t-butyl ether | | | | | | | |
| Dipropylene glycol | — | 100 | — | — | — | — | — |
| mono n-butyl ether | | | | | | | |
| Propylene glycol mono | — | — | 100 | 50 | 100 | — | 50 |
| n-butyl ether | | | | | | | |
| [Compound of | | | | | | | |
| Formula (II)] | | | | | | | |
| Propylene glycol | 350 | — | 250 | 100 | 200 | 350 | 100 |
| Dipropylene glycol | — | 350 | — | 250 | 100 | — | 250 |
| Hydroxy- | — | — | — | — | — | 35 | — |
| propylcellulose | | | | | | | |
| (HPC low molecular | | | | | | | |
| weight) | | | | | | | |
| Vinyl methyl | — | — | — | — | — | — | 30 |
| ether/maleic acid | | | | | | | |
| copolymer | | | | | | | |
| (GANTREZ S-95: low | | | | | | | |
| molecular weight) | | | | | | | |
| [pH-buffering agent] | | | | | | | |
| Malic acid | 15 | 15 | 15 | 15 | 15 | 15 | 15 |
| Ammonium citrate | 10 | 10 | 10 | 10 | 10 | 10 | 10 |
| Phosphoric acid (85%) | 3 | 3 | 3 | 3 | 3 | 3 | 3 |
| [Antiseptic agent] | | | | | | | |
| 4-Isothiazoline-3-one | 2 | 2 | 2 | 2 | 2 | 2 | 2 |
| derivative | | | | | | | |

| | |
|---|---|
| Pure water | Up to 1000 ml in total volume of the |
| | composition |

The compositions for Examples 1 to 20 and Comparative Examples 1 to 7 prepared above were diluted with a dilution rate of 40 times with simulated hard water having a hardness of 400ppm, and adjusted about pH 4.8 to 5.3 with NaOH/phosphoric acid (85%) to obtain a dampening water composition in practical use which is subjected to printing tests.

The following printing tests were conducted using HEIDELBERG MOV (ALCOLOR) as a printing machine, a cyanogen ink under the trade name of Hyecoo manufactured by Toyo Ink Co., Ltd., and a printing plate which was made up from VPS (Fuji Photo Film Co., Ltd.) under standard conditions. The results obtained are summarized in Table 5.

(a) Latitude for Stable Printing

As to a water supply scale of from 1 to 100 in the printing machine, which scale is also a measure for rotational frequency of a feed water roller, the latitude wherein the printing was allowed was observed.

∘ . . . 40˜100

Δ . . . 60˜100

× . . . 80˜100

×× . . . Printing was not allowed.

(b) Stability of a Feed Water Roller

Printing of 10,000 sheets per day was performed continuously for 3 days. After the first day (after the printing of 10,000 sheets), the second day (after the printing of 20,000 sheets) and the third day (after the printing of 30,000 sheets), contamination on the surface of the feed water roller was observed, and more specifically it was observed whether a water film was produced on the surface of the feed water roller uniformly and neatly.

∘ . . . Contamination was hardly observed.

Δ . . . Contamination was slightly observed.

× . . . Contamination was observed.

(c) Bleeding of Ink

After the printing of 5,000 sheets or 10,000 sheets, the operation of printing machine was stopped and it was observed how the ink bled from the image areas to the non-image areas.

∘ . . . Bleeding was hardly observed.

Δ . . . Bleeding was slightly observed.

× . . . Bleeding was rather observed.

(d) Printing Properties for Metal Pigment Ink or UV Ink

Ink compositions used were Gold Ink (blur shade) manufactured by Megami Ink Co., Ltd. and Bestcure Rouge (UV ink, a trade name) manufactured by Toka Sikiso Co., Ltd.

∘ . . . Printing of 5,000 sheets was favorably performed.

Δ . . . Ink contamination was observed on the surface of the blanket (the printing plate was cleaned once during the printing operation).

× . . . Ink contamination was observed at the time of printing of about 1,000 sheets (the printing plate and the blanket were cleaned twice, respectively, during the printing operation).

TABLE 5

| | | Stability of a | | | | Printing | |
|---|---|---|---|---|---|---|---|
| | Latitude | Feed Water | | | | Properties | |
| | for | Roller | | | Bleed- | Metal | |
| | Stable | 1st | 2nd | 3rd | ing | Pigment | |
| | Printing | day | day | day | of Ink | ink | UV ink |
| Example | | | | | | | |
| 1 | ◯ | ◯ | ◯ | ◯ | ◯ | ◯ | ◯ |
| 2 | ◯ | ◯ | Δ | Δ | ◯ | ◯ | ◯ |
| 3 | ◯ | ◯ | ◯ | ◯ | ◯ | ◯ | ◯ |
| 4 | ◯ | ◯ | ◯ | ◯ | ◯ | ◯ | ◯ |
| 5 | ◯ | ◯ | ◯ | ◯ | ◯ | ◯ | ◯ |
| 6 | ◯ | ◯ | ◯ | ◯ | ◯ | ◯ | ◯ |
| 7 | ◯ | ◯ | ◯ | ◯ | ◯ | ◯ | ◯ |
| 8 | ◯ | ◯ | ◯ | ◯ | ◯ | ◯ | ◯ |
| 9 | ◯ | ◯ | ◯ | ◯ | ◯ | ◯ | ◯ |
| 10 | ◯ | ◯ | ◯ | ◯ | ◯ | ◯ | ◯ |
| 11 | ◯ | ◯ | ◯ | ◯ | ◯ | ◯ | ◯ |
| 12 | ◯ | ◯ | ◯ | ◯ | ◯ | ◯ | ◯ |
| 13 | ◯ | ◯ | ◯ | ◯ | ◯ | ◯ | ◯ |
| 14 | ◯ | ◯ | ◯ | ◯ | ◯ | ◯ | ◯ |
| 15 | ◯ | ◯ | ◯ | ◯ | ◯ | ◯ | ◯ |
| 16 | ◯ | ◯ | ◯ | ◯ | ◯ | ◯ | ◯ |
| 17 | ◯ | ◯ | ◯ | ◯ | ◯ | ◯ | ◯ |
| 18 | ◯ | ◯ | ◯ | ◯ | ◯ | ◯ | ◯ |
| 19 | ◯ | ◯ | ◯ | ◯ | ◯ | ◯ | ◯ |
| 20 | ◯ | ◯ | ◯ | ◯ | ◯ | ◯ | ◯ |
| Com. Ex. | | | | | | | |
| 1 | X | X | — | — | — | — | — |
| 2 | XX | — | — | — | — | — | — |
| 3 | XX | — | — | — | — | — | — |
| 4 | Δ | X | — | — | Δ | X | X |
| 5 | XX | — | — | — | — | — | — |
| 6 | X | Δ | — | — | Δ | Δ | Δ |
| 7 | XX | — | — | — | — | — | — |

—: Test was impossible.

As seen from the above results, it is found that the dampening water composition according to the present invention is excellent in all the above tests, and provides favorable printing matters, and exhibits excellent dampening water properties.

Effect of the Invention

The dampening water composition of the present invention can provide stably a uniform water film on a chromium roller and a rubber roller which are used in the dampening water feeding devise of continuous feed water system, and on the printing plate of lithographic printing plate. The dampening water composition of the present invention is comfortable and highly safe in working atmosphere. The use of polyvinylpyrrolidone can decrease the amount of other organic solvents to be used, and evaporation caused by the organic solvent is decreased, and therefore stability of printing is improved.

The dampening water composition of the present invention can exhibit favorable dynamic wetting properties on a roller and a printing plate, under the conditions of members of a printing machine which rotate at high speed, and therefore provides stably excellent printing matters. In particular, in case of the use of a metal pigment ink or UV ink which is said to be conventionally difficult to be printed using a dampening water, the printing properties can be improved. The dampening water composition of the present invention can be used stably for an extended period, and therefore it brings improvement of a productivity rate.

What is claimed is:

1. A dampening water composition for a lithographic printing plate comprising polyvinylpyrrolidone and at least one compound selected from the group consisting of acetylene alcohol, acetylene glycol, n-butyl alcohol, isobutyl alcohol, secondary-butyl alcohol, tertiary-butyl alcohol, a compound of (CH₃)₃C—O—(—CH₂—CH₂—O—)ₚ—H wherein p represents an integer of from 1 to 3, 3-methoxy-3-methylbutanol, 3-methoxybutanol, a compound represented by the following formula (I) and a compound represented by the following formula (II). 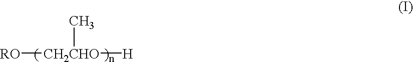
(wherein R represents n-butyl, isobutyl, tertiary-butyl or secondary-butyl group, and n represents an integer of 1 or 2.) 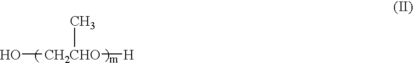
(wherein m represents an integer of from 1 to 3.)

2. A dampening water composition for a lithographic printing plate according to claim 1, which comprises polyvinylpyrrolidone and at least one selected from the group consisting of acetylene alcohol and acetylene glycol.

3. A dampening water composition for a lithographic printing plate according to claim 2, wherein acetylene glycol is selected from 3,6-dimethyl-4-octine-3,6-diol, 2,4,7,9-tetramethyl-5-decyne-4,7-diol and an ethylene oxide adduct of 2,4,7,9-tetramethyl-5-decyne-4,7-diol.

4. A dampening water composition for a lithographic printing plate according to claim 1, which comprises polyvinylpyrrolidone and at lease one selected from the group consisting of n-butyl alcohol, isobutyl alcohol, secondary-butyl alcohol and tertiary-butyl alcohol.

5. A dampening water composition for a lithographic printing plate according to claim 1, which comprises polyvinylpyrrolidone and at least one selected from the group consisting of a compound of (CH₃)₃C—O—(—CH₂—CH₂—O—)ₚ—H wherein p represents an integer of from 1 to 3, 3-methoxy-3-methylbutanol and 3-methoxybutanol.

6. A dampening water composition for a lithographic printing plate according to claim 1, which comprises polyvinylpyrrolidone, a compound represented by the following formula (I) and a compound represented by the following formula (II). 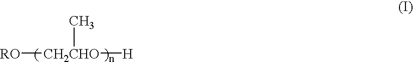
(wherein R represents n-butyl, isobutyl, tertiary-butyl or secondary-butyl group, and n represents an integer of 1 or 2.) 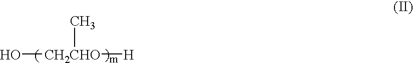
(wherein m represents an integer of from 1 to 3.)

7. A dampening water composition for a lithographic printing plate according to claim 1, wherein the amount of polyvinylpyrrolidone ranges from 0.001 to 0.5% by weight.

8. A dampening water composition for a lithographic printing plate according to claim 2, wherein the amount of at least one selected from the group consisting of acetylene alcohol and acetylene glycol ranges from 0.001 to 0.2% by weight.

9. A dampening water composition for a lithographic printing plate according to claim 4, wherein the amount of at least one selected from the group consisting of n-butyl alcohol, isobutyl alcohol, secondary-butyl alcohol and tertiary-butyl alcohol ranges from 0.1 to 3.0% by weight.

10. A dampening water composition for a lithographic printing plate according to claim 5, wherein the amount of at least one selected from the group consisting of a compound of (CH₃)₃C—O—(—CH₂—CH₂—O—)ₚ—H wherein p represents an integer of from 1 to 3, 3-methoxy-3-methylbutanol and 3-methoxy-butanol ranges from 0.01 to 5.0% by weight.

11. A dampening water composition for a lithographic printing plate according to claim 6, wherein the amount of the compound represented by the formula (I) ranges from 0.05 to 2.0% by weight and the amount of the compound represented by the formula (II) ranges from 0.1 to 3.0% by weight.
